(19) United States
(12) Patent Application Publication
(10) Pub. No.: US 2008/0290196 A1
(43) Pub. Date: Nov. 27, 2008

(54) Deformation-Optimized Armature Guide For Solenoid Valves

(76) Inventors: Andreas Rettich, Herrenberg (DE); Stefan Haug, Waldenbuch (DE); Markus Rueckle, Stuttgart (DE); Stephan Amelang, Koenigsbach-Stein (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/096,488

(22) PCT Filed: Oct. 16, 2006
(86) PCT No.: PCT/EP2006/067411

§ 371 Date: Jun. 6, 2008

(30) Foreign Application Priority Data
Dec. 7, 2005 (DE) 102005058302.4

(51) Int. Cl. F02M 47/02; F02M 63/00; F02M 61/16

(52) U.S. Cl. 239/584

(57) ABSTRACT

The invention relates to a fuel injector having a solenoid valve for actuating an armature assembly which is configured in one piece or a plurality of pieces. A closing element is actuated via this in order to relieve the pressure in a control chamber. The armature assembly is guided in an armature guide which is fastened in the injector body by means of a valve-clamping screw. In a fixing region in the injector body, the armature guide has at least one circumferential recess which allows for deformation of the fixing region during fastening by the valve-clamping screw.

### PRIOR ART

DE 196 50 865 A1 describes a solenoid valve for controlling a fuel pressure in a control chamber of an injection valve, for example of a common rail injection system. The fuel pressure in the control chamber is used to control a stroke motion of a valve piston that opens or closes an injection opening of the injection valve. The solenoid valve has an electromagnet, a moving armature, and a valve member, which is moved by the armature and is acted on in the closing direction by a valve closing spring; the valve member cooperates with the valve seat of the solenoid valve, thus controlling the flow of fuel out of the control chamber.

Known solenoid valves have the disadvantage of the oscillation of the armature and/or chattering of the valve member occurring during operation. A postoscillation of the armature plate that strikes the valve seat causes the armature plate to assume an indefinite position. As a result, in subsequent injections, the same triggering results in different opening times of the solenoid valve and consequently a variation in the injection onset and injection quantity. According to DE 196 50 865 A1 and DE 197 08 104 A1, the armature of the solenoid valve is embodied in the form of a two-part armature unit in order to reduce the moving mass of the unit composed of the armature and valve member and thus to reduce the kinetic energy causing the chattering. The two-part armature includes an armature pin and an armature plate, which is accommodated on the armature pin in such a way that it is able to slide due to the action of its inertial mass in opposition to the force of a return spring in the closing direction of the valve member and is secured on the armature pin by means of a retaining washer and a retaining sleeve encompassing this washer. The retaining sleeve and retaining washer are encompassed by the magnet core, therefore requiring more space and resulting in a larger diameter in the magnet core. The larger diameter in the magnet core in turn results in a limitation of the magnetic flux.

Setting the maximum travel distance available to the armature plate as a sliding path on the armature pin in an exact fashion has turned out to be problematic. The maximum travel distance, which is referred to as the stroke and constitutes the sum of the armature stroke and the excess stroke, is generally measured with a standardizing washer. Then a size-classified adjusting washer is inserted in order to set the desired stroke. The magnet assembly is then screw-connected to the injector body and then the stroke is measured in the screw-connected, clamped state. For actual use, tolerances for the stroke can at most be toleranced in the micrometer range in order to assure a reproduced injector behavior. So that the strict tolerance limits are also actually maintained, it is frequently necessary to disassemble the entire magnet assembly. The process may need to be repeated several times until acceptable tolerance values are achieved; this results in high production costs, though.

To avoid a disassembly of the entire magnet assembly in order to precisely set the stroke, DE 102 32 718 A1 describes a preassembly of an armature unit. In this case, the armature unit includes an armature pin, an armature plate, and a valve-clamping screw embodied in the form of a close-tolerance bolt with an armature pin guide section. A preassembly occurring outside the injector body permits a joint setting of the tolerance of the armature stroke and excess stroke by means of a conically or cylindrically embodied close-tolerance bolt that connects the armature plate to the armature pin. It turns out to be disadvantageous that the number of elements to be assembled increases. In order to set a predetermined stroke, strict tolerances must be maintained for the elements that are to be connected—i.e. the close-tolerance bolt, the armature pin, and the armature plate—as well as for the accommodation openings of the close-tolerance bolt.

Simulation trials and measurements have demonstrated that when screwing in the valve-clamping screw and therefore when fixing the armature guide in the injector housing of a fuel injector, a deformation of the armature guide occurs. During operation, this deformation can result in a breach of the lubricant film so that the friction between the armature pin and the armature guide increases significantly. This friction in turn results in a widely varying closing behavior of the armature pin and therefore results in varying valve opening times.

### DISCLOSURE OF THE PRESENT INVENTION

The object underlying the embodiment according to the present invention is to reduce the deformation of an armature guide during the process of its being fixed inside the injector body of a fuel injector.

To that end, according to the present invention, a recess is let into the component representing the armature guide and the elastic deformation of this component in the injector body as it is being fixed in position, e.g. by means of a valve-clamping screw, is shifted into this recess. The shifting of the elastic deformation of the component representing the armature guide reduces the radial constriction of the latter that hinders the movement of the armature pin of a one-part or multipart armature unit in the component representing the armature guide. A radial constriction of the component representing the armature guide increases the friction between the armature pin of a one-part or multipart armature unit, thus impermissibly hindering the stroke motion of the armature pin.

The embodiment proposed according to the present invention permits a reduction of the radial constriction of the component representing the armature guide so that in addition, the lubricant film produced between the armature pin and the inside of the component representing the armature guide is maintained and a material contact can be avoided between the material of the armature pin and the material of the component representing the armature guide.

### DRAWINGS

The present invention will be described in greater detail below in conjunction with the drawings.

FIG. 1 shows a solenoid valve for a fuel injector with a multipart armature unit,

FIG. 2 is an enlarged depiction of the way in which a valve-clamping screw deforms the component representing the armature guide, and

FIG. 3 is an enlarged depiction of the armature guide.

### EXEMPLARY EMBODIMENT

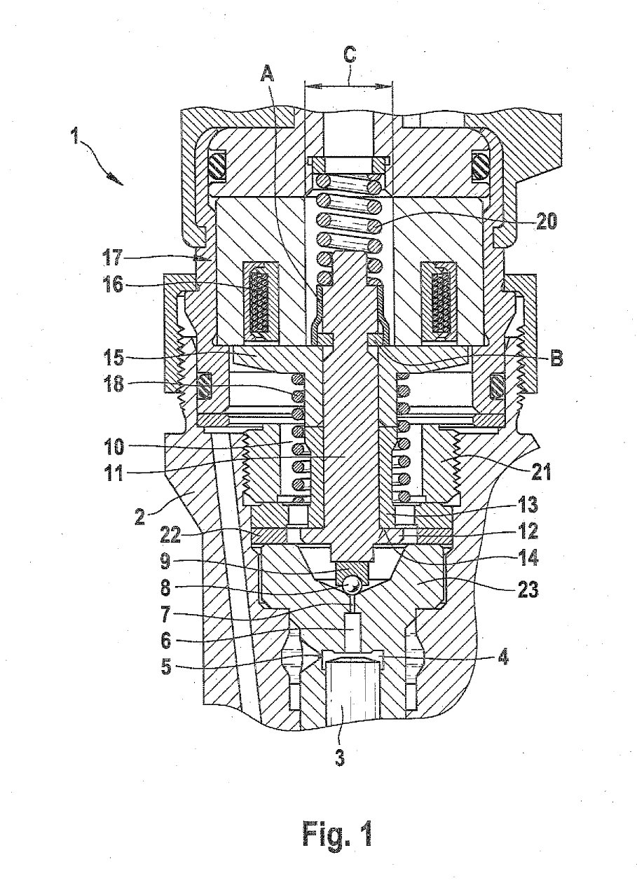

FIG. 1 shows a section through a solenoid valve of a fuel injector with an armature unit that is composed of multiple parts and has an armature pin and an armature plate accommodated thereon.

The fuel injector shown in FIG. 1 has an injector body 2 in which an injection valve member 3 is guided in a movable fashion. The pressure prevailing in a control chamber 4 acts on an end surface of the injection valve member 3. The control chamber 4 is filled via an inlet throttle 5. A closure element 8, which closes a pressure-relief conduit 6 containing an outlet throttle 7, is used to relieve the pressure in the control chamber 4. The ball-shaped closure element 8 in FIG. 1 is accommodated in a closure element guide body 9. The closure element guide body 9 is accommodated on an armature pin 11 of a multipart armature 10. On the underside of the armature pin 11, there is a disk-shaped stop 12. The armature pin 11 is enclosed by an armature guide 13. The armature pin 11 also accommodates an armature plate 15. The armature plate 15 is enclosed by an armature spring 18 that acts on the underside of the armature plate 15 and also encloses the armature guide 13. In the upper part of the fuel injector 1 there is a solenoid valve 17, which has an electromagnet 16. The magnet core of the electromagnet 16 has a bore C embodied with a first diameter into which the upper end of the armature pin 11 protrudes. At the upper end of the armature pin 11, there is a retaining washer B that is encompassed by a retaining sleeve A. Because of the selected arrangement, the dimension C, i.e. the diameter of the bore provided in the magnet core, must be selected so as to accommodate the retaining sleeve A and the retaining washer B inside it.

A valve spring 20 prestresses the armature unit 10, which includes the armature pin 11 and the armature plate 15 guided on it. The valve-clamping screw 21 places the armature guide 13 against an adjusting washer 22, which in turn rests against a valve component 23.

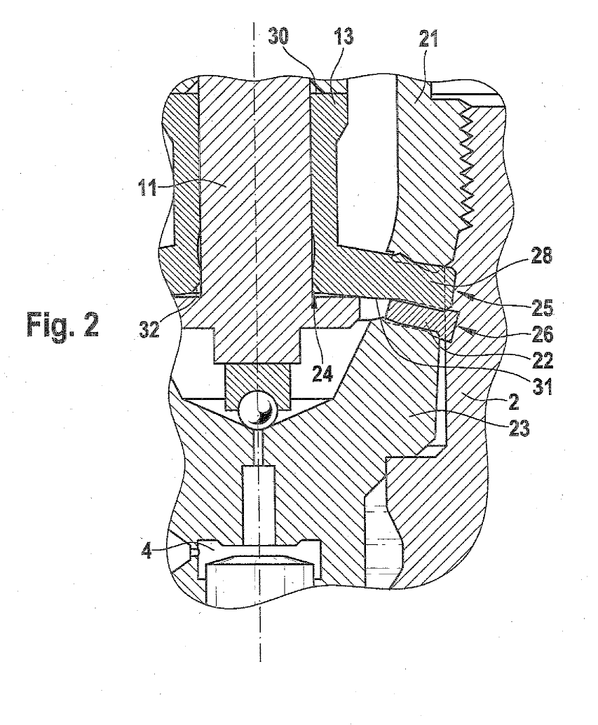

FIG. 2 is an enlarged depiction of the deformation of the armature guide of the adjusting washer and of the end surface of the valve component.

It is clear from the depiction in FIG. 2 that when the valve-clamping screw 21 is tightened with a predetermined torque, this deforms a disk-shaped fixing region 28 at the lower end of the armature guide 13 so that a deformation 25 occurs. Due to the deformation 25, a radial constriction 24 occurs between the outer surface of the armature pin 11 and the inside of the armature guide 13. In addition to the deformation of the valve-clamping screw 21 and the deformation 25 of the fixing region 28 of the armature guide 13, the adjusting washer 22 on which the fixing region 28 of the armature guide 13 rests also assumes a deformed state 26. Finally, the upper end surface of the valve component 23, which is shown in the enlarged view in FIG. 2, is also deformed when a predefined tightening torque is exerted on the valve-clamping screw 21, as shown in FIG. 2. For symmetry reasons, only one half of the armature guide 13 is depicted; FIG. 2 likewise only shows one half of the valve-clamping screw 21 and one half of the valve component 23.

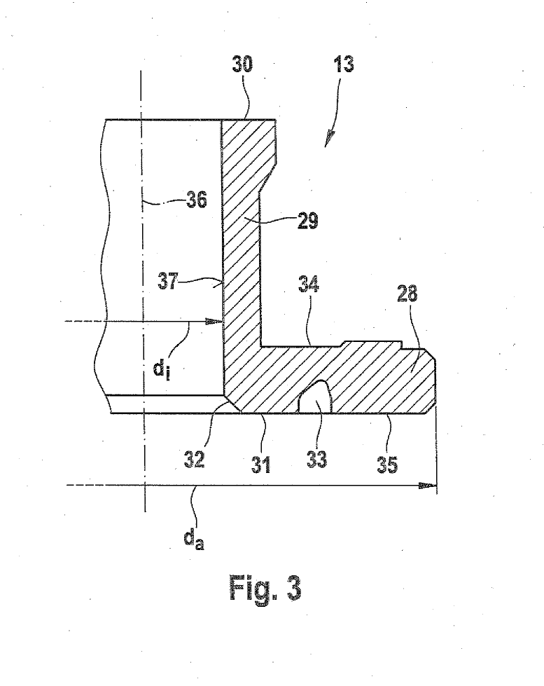

FIG. 3 is an enlarged depiction of an armature guide.

It is clear from the depiction in FIG. 3 that the armature guide 13 has a first end surface 30 on which the armature plate 15 rests according to the depiction in FIG. 1. The armature guide 13 also includes the fixing region 28, which is shown in its deformed state in FIG. 2 and which the valve-clamping screw 21 places against the adjusting washer 22, which is preferably a size-classified adjusting washer. The fixing region 28 of the armature guide 13 according to FIG. 3 includes an upper surface 34 and a lower surface 35. The lower surface 35 has a circumferential recess 33 let into it, which can be embodied as groove-shaped, for example, and serves as a stress-relief element. On the inner circumference surface of the armature guide 23, there is a guide surface 37 for the armature pin 11. The circumference surface of the armature pin 11 and the inner circumference surface of the armature guide 13, i.e. the guide surface 37 for the armature pin 11, are produced with a high surface quality. Between the armature pin 11, which is not shown in FIG. 3, and the guide surface 34, a lubricant film is formed, which reduces the friction between the armature pin 11 and the guide surface 37 of the armature guide 13 when the electromagnet 16 shown in FIG. 1 is actuated.

If the action of the valve-clamping screw 21 shown in FIG. 2 places the armature guide 13 shown in FIG. 3 against the adjusting washer 22 likewise shown in FIG. 2, then the clamping force deforms the fixing region 28. Due to the presence of the circumferential recess 33 provided in the underside 35 of the fixing region 28, however, the disk-shaped fixing region 28 can in fact be compressed, which means that the circumferential recess 33 does not prevent the elastic deformation of the fixing region 28 when it is acted on by the torque of the valve-clamping screw 21, but instead absorbs the material displaced by the clamping. While the stretching of the upper surface 34 of the fixing region 28 is not critical with regard to a radial constriction 24 of the armature guide 13, the circumferential recess 3 on the underside 35 of the fixing region 28 promotes a flow of the material of the armature guide 13 so that a material displacement due to compression can occur on the underside 35 of the fixing region 28, and the compression during the clamping of the fixing region 28 by the tightening of the valve-clamping screw 21 does not result in the radial constriction 24 depicted in FIG. 2. It is consequently possible to maintain the lubricant film that forms between the armature pin 11 and the guide surface 37 of the armature guide 13, which in fuel injectors, is composed of the fuel, for example. In the case of autoignition internal combustion engines, the lubricant is therefore diesel fuel.

A material displacement on the underside 35 of the fixing region 28 that occurs with the tightening of the valve-clamping screw 21 is consequently absorbed by the circumferential recess 33. As a result, there is little or no deformation of the guide surface 37 oriented toward the armature pin 11 on the inside of the component representing the armature guide 13. Primarily, 100Cr6 is used as the material of the armature pin 11 and of the armature guide 13 encompassing it. The valve-clamping screw 21, which acts on the fixing region 28 of the armature guide 13 with a definite tightening torque, rests on the upper surface 34 of the raised surface in the fixing region 28.

The armature guide 13 shown in FIG. 3 makes it possible to achieve a radial constriction of 0.0212 μm with a valve-clamping screw force of approximately 18 kN. In lieu of one circumferential recess 33, it is also possible for a plurality of circumferential recesses 33 to be provided concentric to one another on the underside 35 of the fixing region 28 of the armature guide 13. The armature guide 13 shown in FIG. 3 has a recess 33 serving as a stress-relief element embodied on the underside 35 of the fixing region 28. Alternatively, the circumferential recess 33 can also be let into the upper surface 34 of the fixing region 28, but this is not depicted in the drawings.

1-9. (canceled)

10. A fuel injector, comprising:
injector body;
an armature guide disposed in the injector body;
an armature unit guided within the armature guide;
a valve closure element actuated by the armature unit;
a control chamber being opened and closed by the valve closure element; and
a valve-clamping screw disposed on the armature guide and fastening the armature guide in the injector body, wherein the armature guide is embodied by at least one circumferential recess in a fixing region of the armature guide.

11. The fuel injector according to claim 10, wherein the fixing region is embodied as disk-shaped and includes the at least one circumferential recess in either an upper surface or a lower surface of the disk-shaped fixing region.

12. The fuel injector according to claim 10, wherein the at least one circumferential recess is embodied in the form of a stress-relief groove.

13. The fuel injector according to claim 10, wherein the at least one circumferential recess extends in a diameter region situated between an outer diameter dₐ of the fixing region and an inner diameter dᵢ of the armature guide.

14. The fuel injector according to claim 13, where the at least one circumferential recess extends at a diameter of (dₐ+dᵢ)/2.

15. The fuel injector according to claim 10, wherein the armature guide has a guide surface that ends at a bevel in the region of an end surface.

16. The fuel injector according to claim 10, wherein the armature guide has a radial constriction of less than 0.03 μm when clamped by the valve-clamping screw.

17. The fuel injector according to claim 16, wherein the radial constriction is less than 0.02 μm.

18. The fuel injector according to claim 11, wherein the fixing region is provided with a support surface for the valve-clamping screw on the upper surface thereof.
